(19) United States
(12) Patent Application Publication
(10) Pub. No.: US 2006/0208658 A1
(43) Pub. Date: Sep. 21, 2006

(54) Light emitting device

(75) Inventor: Ji Hun Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/376,176

(22) Filed: Mar. 16, 2006

(30) Foreign Application Priority Data
Mar. 18, 2005 (KR) 10-2005-0022736

(51) Int. Cl. G09G 3/10

(52) U.S. Cl. 315/169.3

(57) ABSTRACT

The present invention relates to a light emitting device for preventing a cross-talk phenomenon. The light emitting device includes anode electrode layers, cathode electrode layers and a scan line. The anode electrode layers are disposed in a first direction. The cathode electrode layers are disposed in a second direction different from the first direction. The scan line is coupled to one or more cathode electrode layer. The light emitting device uses a wide scan line, and so the cross-talk phenomenon is not occurred to the light emitting device.

### BACKGROUND OF THE INVENTION

1. Field of the Invention

The present invention relates to a light emitting device. More particularly, the present invention relates to a light emitting device for preventing a cross-talk phenomenon.

2. Description of the Related Art A light emitting device emits a light having a certain wavelength when a predetermined voltage is applied thereto.

FIG. 1A is a view illustrating a common organic electroluminescent device. FIG. 1B is a view illustrating a circuitry of the organic electroluminescent device of FIG. 1A.

In FIG. 1A, the organic electroluminescent device includes anode electrode layers 100, cathode electrode layers 102, pixels 104, a driver 106, data lines 108 and scan lines 110.

Each of the anode electrode layers 100 is made up of indium tin oxide.

Each of the cathode electrode layers 102 is made up of metal.

The pixels 104 are formed in cross areas of the anode electrode layers 100 and the cathode electrode layers 102.

The data lines 108 are connected to the anode electrode layers 100, respectively.

The scan lines 110 are connected to the cathode electrode layers 102, respectively.

The driver 106 includes a data driving circuit 112 and a scan driving circuit 114.

The data driving circuit 112 transmits a plurality of data signals to the anode electrode layers 100 through the data lines 108.

The scan driving circuit 114 transmits a plurality of scan signals to the cathode electrode layers 102 through the scan lines 110.

Here, the scan lines 110 have self-resistors, and thus the magnitude of the scan signals is reduced depending on the resistors when the scan signals are transmitted to the cathode electrode layers 110. In this case, because the scan lines 110 have small width and different length one another, the scan lines have great resistance difference one another.

In FIG. 1B, a first resistance of a first resistor R1 corresponding to a first scan line 110A is higher than a second resistance of a second resistor R2 corresponding to a second scan line 110B. The second resistance is higher than a third resistance of a third resistor R3 corresponding to a third scan line 110C. The third resistance is higher than a fourth resistance of a fourth resistor R4 corresponding to a fourth scan line 110D. Here, the width of the scan lines is narrow, and thus difference among the resistances is great.

Hereinafter, the brightness of the pixels E11 to E44 in FIG. 1B will be described in detail. Here, the brightness of a pixel E11 corresponding to the first scan line S1 will be compared with that of a pixel E12 corresponding to the second scan line S2 for convenience of the description. In addition, the data signals, i.e. data current provided from the data driving circuit 112 to the data lines D1 to D4 are assumed as the same magnitude one another.

The first resistance is higher than the second resistance, and thus a 11 cathode voltage of the pixel E11 is higher than a 12 cathode voltage of the pixel E12. However, because anode voltages of the pixels E11 and E12 is in proportion to the data current, a 11 anode voltage of the pixel E11 is identical to a 12 anode voltage of the pixel E12.

On the other hand, the pixel E11 emits a light with the brightness corresponding to difference of its anode voltage and cathode voltage. The pixel E12 emits a light with the brightness corresponding to difference of its anode voltage and the cathode voltage. Accordingly, though the pixel E12 is designed to emit a light having the same brightness as the pixel E11, the pixel E12 emits the light having brightness smaller than the pixel E11.

In short, though the pixels E11 to E44 are designed to emit light having the same brightness, the pixels E11 to E44 emit light having different brightness depending on the scan line. This is referred to as “cross-talk phenomenon”. Accordingly, there has been a need for an organic electroluminescent device for preventing the cross-talk phenomenon.

### SUMMARY OF THE INVENTION

It is a feature of the present invention to provide a light emitting device for preventing a cross-talk phenomenon.

A light emitting device according to one embodiment of the present invention includes anode electrode layers, cathode electrode layers and a scan line. The anode electrode layers are disposed in a first direction. The cathode electrode layers are disposed in a second direction different from the first direction. The scan line is coupled to one or more cathode electrode layer.

An electroluminescent device of the present invention includes anode electrode layers, cathode electrode layers, pixels and a scan line. The anode electrode layers are disposed in a first direction. The cathode electrode layers are disposed in a second direction different from the first direction. The pixels are formed in cross areas of the anode electrode layers and the cathode electrode layers. The scan line is coupled to the cathode electrode layers. Here, a point of time at which a first cathode electrode layer of the cathode electrode layers is connected to the scan line is different from that of time at which a second cathode electrode layer is connected to the scan line.

A light emitting device of the present invention includes anode electrode layers, cathode electrode layers, a first scan line and a second scan line. The anode electrode layers are disposed in a first direction. The cathode electrode layers are disposed in a second direction different from the first direction. The first scan line is coupled to a part of the cathode electrode layers. The second scan line is coupled to other cathode electrode layers.

As described above, the light emitting device of the present invention uses a wide scan line, and so the cross-talk phenomenon is not occurred to the light emitting device.

In addition, the light emitting device of the present invention uses a wide scan line, and thus though the light emitting device is increased in size, the increased light emitting device may emit a light having the same brightness as the original light emitting device with a little increased driving voltage.

### BRIEF DESCRIPTION OF THE DRAWINGS

The above and other features and advantages of the present invention will become readily apparent by reference to the following detailed description when considered in conjunction with the accompanying drawings wherein:

FIG. 1A is a view illustrating a common organic electroluminescent device;

FIG. 1B is a view illustrating a circuitry of the organic electroluminescent device of FIG. 1A;

FIG. 2A is a view illustrating a light emitting device of a first embodiment of the present invention;

FIG. 2B is a view illustrating a circuitry of the light emitting device of FIG. 2A; and

FIG. 3 is a view illustrating a light emitting device according to a second embodiment of the present invention.

### DESCRIPTION OF EMBODIMENTS

Hereinafter, the preferred embodiments of the present invention will be explained in more detail with reference to the accompanying drawings.

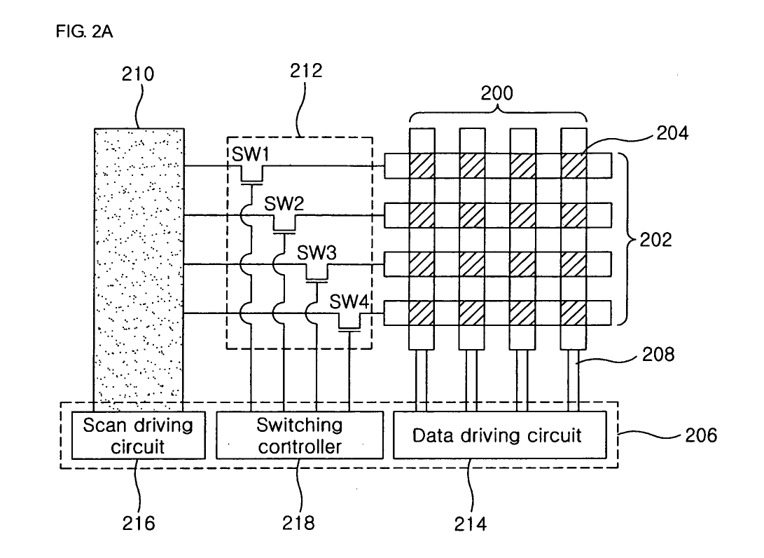

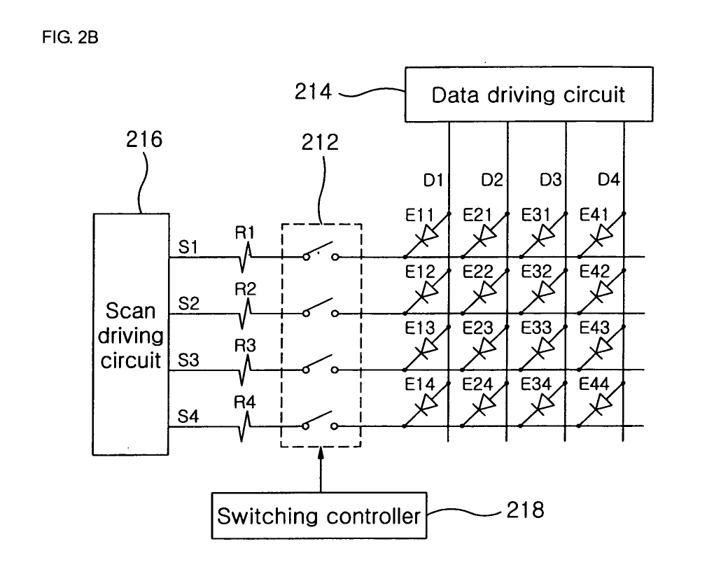

FIG. 2A is a view illustrating a light emitting device of a first embodiment of the present invention. FIG. 2B is a view illustrating a circuitry of the light emitting device of FIG. 2A.

In FIG. 2A, the light emitting device of the present invention includes anode electrode layers 200, cathode electrode layers 202, pixels 204, a driver 206, data lines 208, a scan line 210 and a switching circuit 212.

The light emitting device according to one embodiment of the present invention includes an organic electroluminescent device, a plasma display panel, a liquid crystal display, and others. Hereinafter, the organic electroluminescent device will be described as an example of the light emitting device for convenience of the description.

The anode electrode layers 200 are conductive layers, for example are made up of indium tin oxide.

The cathode electrode layers 202 are metal layers, for example are made up of aluminum (Al).

The pixels 204 are formed in cross areas of the anode electrode layers 200 and the cathode electrode layers 202.

One or more pixel includes the anode electrode layer 200, an organic layer and the cathode electrode layer 202 deposited in sequence on a substrate (not shown).

The organic layer includes a hole transporting layer (HTL), an emitting layer (EML) and an electron transporting layer (ETL) deposited in sequence on the anode electrode layer 200.

When a positive voltage and a negative voltage are provided to the anode electrode layer 200 and the cathode electrode layer 202, respectively, the HTL transports holes provided from the anode electrode layer 200 to the EML, and the ETL transports electrons provided from the cathode electrode layer 202 to the EML.

Subsequently, the transported holes and electrons are recombined in the EML, and so a light having a certain wavelength is emitted from the EML.

The data lines 208 are coupled to the anode electrode layers 200.

The scan line 210 is coupled to the cathode electrode layers 202 through the switching circuit 208.

The switching circuit 212 includes a plurality of switches SW1 to SW4. Here, the switches SW1 to SW4 according to one embodiment of the present invention are MOS transistors controlled by voltage.

The switches SW1 to SW4 are turned on in sequence, and so the scan line 210 is connected in sequence to the cathode electrode layers 202.

The scan line 210 is wider than the scan line described in the Related Art, preferably has the width of above about 51 μm.

The driver 206 includes a data driving circuit 214, a scan driving circuit 216 and a switching controller 218.

The data driving circuit 214 provides a plurality of data signals, i.e. data current to the anode electrode layers 200.

The scan driving circuit 216 provides a plurality of scan signals to the cathode electrode layers 202 through the scan line 210 and the switches SW1 to SW4.

The switching controller 218 controls on/off of the switches SW1 to SW4, i.e. turns on in sequence the switches SW1 to SW4. In particular, the switching controller 218 turns on only first switch SW1 of the switches SW1 to SW4, and then turns on only second switch SW2. Subsequently, the switching controller 218 turns on only third switch SW3 of the switches SW1 to SW4, and then turns on only fourth switch SW4.

The switching controller 218 repeats the above process, and so the scan line 210 may perform the same function as the scan lines described in Related Art. Additionally, the switching controller 218 according to one embodiment of the present invention controls the switches SW1 to SW4 using voltage so that current drop (IR drop) is not occurred.

In brief, the light emitting device of the present invention uses the scan line 210 wider than the scan lines described in Related Art, and switches the connection of the scan line 210 and the cathode electrode layers 202 using the switches (SW1 to SW4).

In FIG. 2B, a first resistance of a first resistor R1 located between the scan driving circuit 216 and a first cathode electrode layer corresponding to the first switch SW1 is higher than a second resistance of a second resistor R2 located between the scan driving circuit 216 and a second cathode electrode layer corresponding to the second switch SW2. In addition, the second resistance is higher than a third resistance of a third resistor R3 located between the scan driving circuit 216 and a third cathode electrode layer corresponding to the third switch SW3. Further, the third resistance is higher than a fourth resistance of a fourth resistor R4 located between the scan driving circuit 216 and a fourth cathode electrode layer corresponding to the fourth switch SW4. However, the width of the scan line 210 of the present invention is much higher than that of the scan lines in Related Art, and thus the difference of the resistances is much smaller than that of the resistances in Related Art.

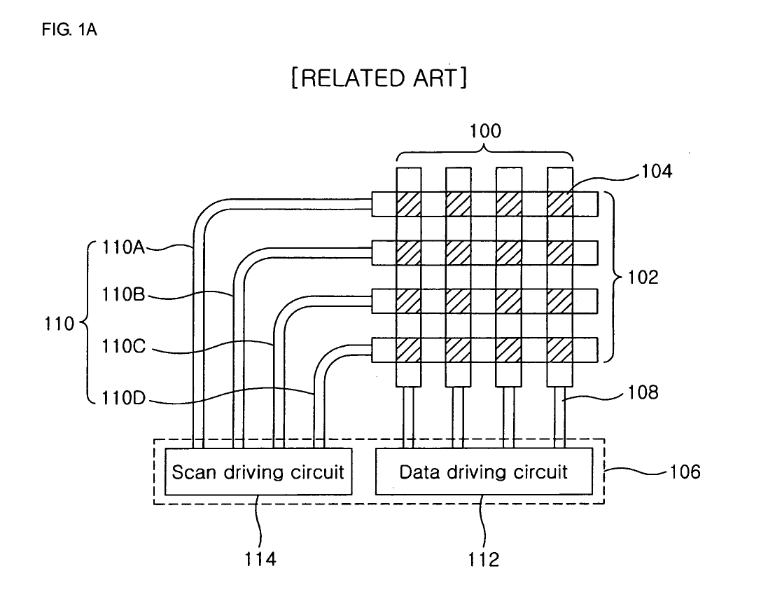

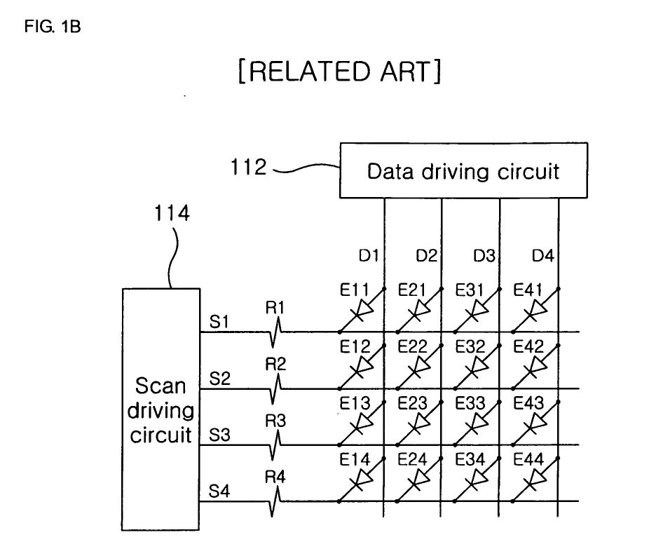

Hereinafter, the brightness of the pixels E11 to E44 in FIG. 1B will be described in detail. Here, the brightness of a pixel E11 corresponding to the first scan line S1 will be compared with that of a pixel E12 corresponding to the second scan line S2 for convenience of the description. In addition, the data signals, i.e. data current provided from the data driving circuit 214 to the data lines Dl to D4 are assumed as the same magnitude one another.

The resistance of the first resistor R1 is higher than that of the second resistor R2, and thus a 11 cathode voltage of the pixel E11 is higher than a 12 cathode voltage of the pixel E12. In this case, the scan line 210 in the present invention is very wide, and so the difference of the 11 cathode voltage and the 12 cathode voltage is small. However, because anode voltages of the pixels E11 and E12 are in proportion to the data current, a 11 anode voltage of the pixel E11 is identical to a 12 anode voltage of the pixel E12.

On the other hand, the pixel E11 emits a light with the brightness corresponding to difference of its anode voltage and cathode voltage. The pixel E12 emits a light with the brightness corresponding to difference of its anode voltage and the cathode voltage. Accordingly, though the pixel E12 is designed to emit a light having the same brightness as the pixel E11, the pixel E12 emits the light having brightness smaller than the pixel E11. In this case, because the difference of the 11 cathode voltage and the 12 cathode voltage is small, the difference of brightness of the pixels E11 and E12 is small. Therefore, people may not discern visually the brightness difference of the pixels E11 and E12. In other words, a cross-talk phenomenon is not occurred in the light emitting device of the present invention.

Hereinafter, the change of a driving voltage in accordance with the size of the light emitting device will be described in detail. Here, the driving voltage is voltage corresponding to data current provided to the pixel when the pixel emits a light having maximum brightness.

In general, in case that the size of the light emitting device, i.e. the number of the pixels is increased, the driving voltage corresponding to the light emitting device is augmented depending on the change of the size. However, in the light emitting device of the present invention, the driving voltage may be changed smaller than in the light emitting device in Related Art.

For example, a first light emitting device having 96 (a number of pixels in a horizontal direction)×64 (a number of pixels in a longitudinal direction) is changed into a second light emitting device having 128 (a number of pixels in a horizontal direction)×96 (a number of pixels in a longitudinal direction). In this case, a first cathode voltage in the light emitting device in Related Art is higher than a second cathode voltage in the light emitting device of the present invention, and thus a first anode voltage corresponding to the first cathode voltage should be higher than a second anode voltage corresponding to the second cathode voltage so that a first pixel corresponding to the first cathode voltage has the same brightness as a second pixel corresponding to the second cathode voltage.

In other words, when the light emitting device is increased in size, the second pixel in the present invention may have the same brightness as the first pixel in Related Art though the driving voltage corresponding to the second pixel is smaller than that corresponding to the first pixel.

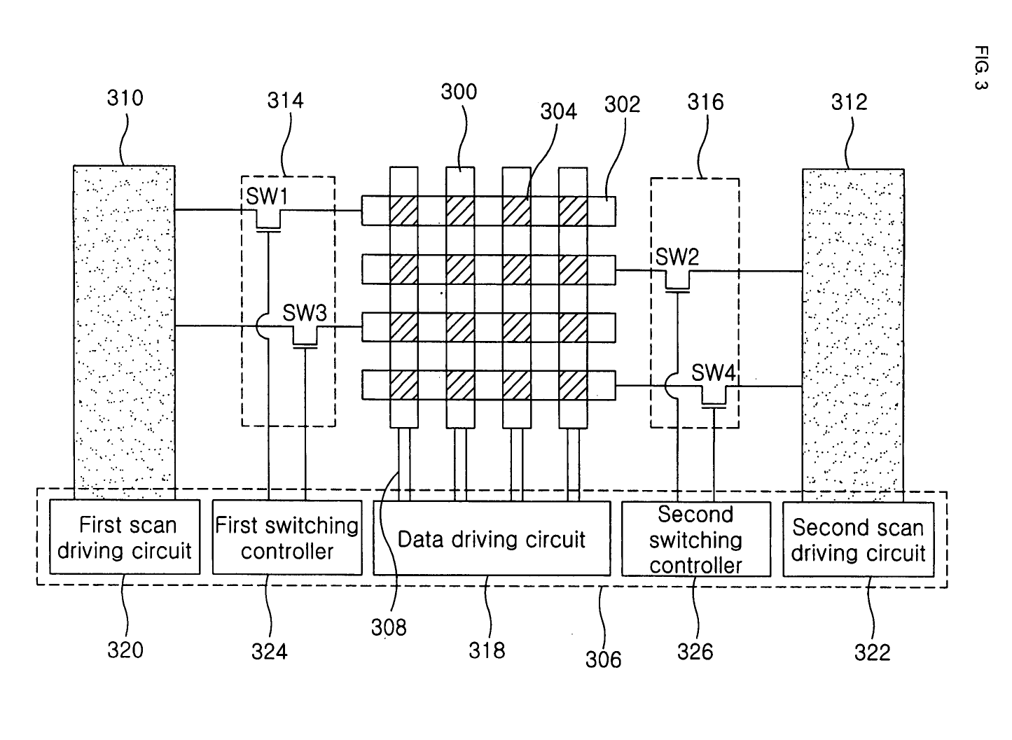

For example, when the size of the light emitting device is changed, the driving voltage in Related Art should be increased up to about 25V so that the first pixel emits a light having 100 candelas. However, the driving voltage in the present invention may be increased up to about 23V so that the second pixel emits a light having 100 candelas. Accordingly, the power consumption in the present invention may be reduced comparing to that in Related Art FIG. 3 is a view illustrating a light emitting device according to a second embodiment of the present invention.

In FIG. 3, the light emitting device of the present invention includes anode electrode layers 300, cathode electrode layers 302, pixels 304, a driver 306, data lines 308, a first scan line 310, a second scan line 312, a first switching circuit 314 and a second switching circuit 316.

Since the elements of the present embodiment except the driver 306, the scan lines 310 and 312, and the switching circuits 314 and 316 are the same as in the embodiment 1, any further detailed descriptions concerning the same elements will be omitted.

The first scan line 310 is coupled to a part of the cathode electrode layers 302 through the first switching circuit 314 in one direction, and is wide.

The second scan line 312 is coupled to other cathode electrode layers through the second switching circuit 316 in another direction, and is wide.

In the light emitting device according to one embodiment of the present invention, the width of the second scan line 312 is substantially identical to that of the first scan line 310, preferably is above about 51 μm.

The first switching circuit 310 includes first switches SW1 and SW3. The second switching circuit 312 includes second switches SW2 and SW4. Here, the switches SW1 to SW4 are turned on in sequence.

The driver 306 includes a data driving circuit 318, a first scan driving circuit 320, a second scan driving circuit 322, a first switching controller 324 and a second switching controller 326.

The data driving circuit 318 transmits a plurality of data signals to the anode electrode layers 300 through the data lines 308.

The first scan driving circuit 320 transmits a plurality of first scan signals to the part of the cathode electrode layers 302 through the first scan line 310 and the first switches SW1 and SW3.

The second scan driving circuit 320 transmits a plurality of second scan signals to the other cathode electrode layers through the second scan line 312 and the second switches SW2 and SW4.

The first switching controller 324 controls the switching of the first switches SW1 and SW3.

The second switching controller 326 controls the switching of the second switches SW2 and SW4.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A light emitting device comprising:
anode electrode layers disposed in a first direction;
cathode electrode layers disposed in a second direction different from the first direction; and
a scan line coupled to one or more cathode electrode layer.

2. The light emitting device of claim 1, further including:
a switching circuit configured to have at least one switch for switching the connection of the cathode electrode layers and the scan line.

3. The light emitting device of claim 2, wherein the switch is MOS transistor.

4. The light emitting device of claim 2, further including:
a switching controller configured to control the switch.

5. The light emitting device of claim 4, wherein the switching controller controls the switch using voltage.

6. The light emitting device of claim 1, wherein the scan line has a width of above about 51 μm.

7. The light emitting device of claim 1, further including:
a scan driving circuit configured to transmit scan signals to the cathode electrode layers through the scan line; and
a data driving circuit configured to transmit data signals to the anode electrode layers.

8. The light emitting device of claim 1, wherein the cathode electrode layers are coupled in sequence to the scan line.

9. The light emitting device of claim 1, wherein the light emitting device is organic electroluminescent device.

10. An electroluminescent device comprising:
anode electrode layers disposed in a first direction;
cathode electrode layers disposed in a second direction different from the first direction;
pixels formed in cross areas of the anode electrode layers and the cathode electrode layers; and
a scan line coupled to the cathode electrode layers;
a point of time at which a first cathode electrode layer of the cathode electrode layers is connected to the scan line is different from that of time at which a second cathode electrode layer is connected to the scan line.

11. The electroluminescent device of claim 10, further including:
a switching controller configured to control the connection of the cathode electrode layers and the scan line;
a scan driving circuit configured to transmit scan signals to the cathode electrode layers through the scan line; and
a data driving circuit configured to transmit data signals to the anode electrode layers.

12. The electroluminescent device of claim 10, wherein a resistor between the scan line and the first cathode electrode layer has different resistance from a resistor between the scan line and the second cathode electrode layer.

13. A light emitting device comprising:
anode electrode layers disposed in a first direction;
cathode electrode layers disposed in a second direction different from the first direction;
a first scan line coupled to a part of the cathode electrode layers; and
a second scan line coupled to other cathode electrode layers.

14. The light emitting device of claim 13, further including:
a first switching circuit configured to switch the connection of the part and the first scan line; and
a second switching circuit configured to switch the connection of the other cathode electrode layers and the second scan line.

15. The light emitting device of claim 14, wherein at least one of the switching circuit includes one or more switch.

16. The light emitting device of claim 15, wherein the switch is MOS transistor.

17. The light emitting device of claim 15, wherein the switch is controlled by voltage.

18. The light emitting device of claim 14, further including:
a first switching controller configured to control the first switching circuit; and
a second switching controller configured to control the second switching circuit.

19. The light emitting device of claim 13, wherein the width of the second scan line is substantially identical to that of the first scan line.

20. The light emitting device of claim 13, wherein at least one of the scan lines has width of above about 51 μm.

21. The light emitting device of claim 13, further including:
a first scan driving circuit configured to transmit first scan signals to the part through the first scan line;
a second scan driving circuit configured to transmit second scan signals to the other cathode electrode layers through the second scan line; and
a data driving circuit configured to transmit data signals to the anode electrode layers.
